(19) United States
(12) Patent Application Publication
(10) Pub. No.: US 2016/0019245 A1
(43) Pub. Date: Jan. 21, 2016

(54) DATABASE CONNECTION TUNING

(71) Applicant: TELEFONAKTIEBOLAGET L M ERICSSON (PUBL), Stockholm (SE)

(72) Inventors: Brindha PADMANAABHAN, Chennai (IN); Manoj PRASANNA KUMAR, Chennai (IN); Subramanian SHIVASHANKAR, Chennai (IN); N Hari KUMAR, Chennai (IN)

(21) Appl. No.: 14/773,198

(22) PCT Filed: Mar. 7, 2013
(86) PCT No.: PCT/SE2013/050200

§ 371 Date: Sep. 4, 2015

(51) Int. Cl. G06F 17/30; G06N 99/00

(52) U.S. Cl. CPC G06F 17/30306; G06F 17/30917; G06N 99/005

(57) ABSTRACT

The present disclosure is directed towards a connection tuning arrangement for tuning connection parameters of databases in a federated database system. The database system includes a least one application configured to access one or more databases. The connection tuning arrangement includes a data stream monitoring unit configured to monitor a number of application specific parameters in data streams of an application, the monitoring being performed in at least one context, and learn the behaviour of the data streams. A performance tuning unit is configured to tune connection parameters based on the behaviour.

### TECHNICAL FIELD

The invention relates to federated database systems. More particularly, the invention relates to a connection tuning arrangement in a federated database system as well as to a method, computer program and computer program product for tuning connection parameters in a federated database system.

### BACKGROUND

Systems like mobile telephone systems may comprise a variety of databases of different types, which databases comprise data and may be accessed by different applications, such as by core applications in a core network or by third party applications.

An application being deployed in such as system may generate data streams for accessing the databases through storing and fetching data in them. In this accessing of the databases the application typically employs connection parameters.

However, it may be necessary to tune these connection parameters or otherwise the performance experienced by a user of the application may be found to be unacceptable.

Such tuning has traditionally been made manually. However manual tuning is not feasible in a federated database system where there are many applications and many databases.

There is therefore a need for improvement in the tuning of connection parameters that may be done in an automatic fashion.

For applications deployed in a federated database system, it is difficult to understand the characteristics of different data streams at particular time instances. In such environments, human effort is intensely required to track the temporal characteristics of data streams and tune the system accordingly for performance requirements such as a quick response time and effective resource utilization.

With the application of data mining it is possible to continuously monitor application specific characteristics of data streams, learn patterns and tune the system dynamically for good performance. The existing solutions in this context are restricted to a single relational database (which is often known to the user). There is no method/approach to handle dynamic performance tuning in a federated setup which consists of both Structured query Language (SqL) and NoSqL databases. Also, systems capable of self monitoring and switching databases automatically based on some characteristics, require manual tuning for a newly switched database. This makes the problem more complex as human effort is needed to understand SqL and NoSqL database technologies to tune the system.

There is therefore a need for improvement with regard to some or all of the above-mentioned problems.

### SUMMARY

One object of the invention is thus to provide an improvement in the handling of queries in a federated database system.

This object is according to a first aspect of the invention achieved by a connection tuning arrangement for tuning connection parameters of databases in a federated database system. The database system comprises a least one application that accesses one or more databases. The connection tuning arrangement comprises

a data stream monitoring unit that
monitors a number of application specific parameters in data streams of an application, the monitoring being performed in at least one context, and
learns the behaviour of the data streams.

The connection tuning arrangement also comprises a performance tuning unit that tunes connection parameters for accessing the databases based on the behaviour.

This object is according to a second aspect also achieved by a method of tuning connection parameters of databases in a federated database system, where the database system comprises applications that access one or more databases. The method is performed in a connection tuning arrangement of the system and comprises:

monitoring a number of application specific parameters in data streams of an application, the monitoring being performed in at least one context,
learning the behaviour of the data streams, and
tuning the connection parameters based on the behaviour.

The object is according to a third aspect of the invention also achieved through a computer program for tuning connection parameters of a database in a federated database system, which database system comprises applications that access one or more databases. The computer program comprises computer program code which when run in a connection tuning arrangement, causes the connection tuning arrangement to:

monitor a number of application specific parameters in data streams of an application, the monitoring being performed in at least one context,
learn the behaviour of the data streams, and
tune connection parameters based on the behaviour.

The object is according to a fourth aspect furthermore achieved by a computer program product for tuning an application in a federated database system, where the computer program product is provided on a data carrier and comprises the computer program code according to the third aspect.

The invention according to the above-mentioned aspects has a number of advantages. The invention provides dynamical tuning of a federated database system, where there may be multiple databases having their own set of characteristics and tuning parameters. Automatic tuning may thus be achieved. This also reduces manual overhead.

In an advantageous variation of the first aspect, the data stream monitoring unit comprises

a combination forming element that
obtains a set of traffic patterns of the application, where each traffic pattern comprises different combinations of the application specific parameters,
forms tuples of combinations of values of variable connection parameters, and
applies settings in the tuples to connection parameters of traffic instances corresponding to the obtained traffic patterns, thereby forming a number of traffic pattern and tuple combinations, and
   a performance determining element that determines the performance of each traffic pattern and tuple combination, where
   the performance tuning unit, when tuning connection parameters based on the behaviour, selects a tuple for use in the context, which tuple is a tuple that best matches a performance criterion with regard to the traffic patterns.

In a corresponding variation of the second aspect, the learning of the behaviour further comprises

obtaining a set of traffic patterns of the application, each traffic pattern comprising different combinations of the application specific parameters, forming tuples of combinations of values of variable connection parameters,
applying settings in the tuples to connection parameters of traffic instances corresponding to the obtained traffic patterns, thereby forming a number of traffic pattern and tuple combinations, and
determining the performance of each traffic pattern and tuple combination, where
the tuning further comprises selecting a tuple for use in the context, which tuple is a tuple that best matches a performance criterion with regard to said traffic patterns.

According to a further variation of the first aspect, the performance tuning unit, when selecting a tuple that best matches the performance criterion, selects the tuple that best matches the performance criterion with regard to all traffic patterns of the context.

According to a corresponding variation of the second aspect, the selecting of a tuple that best matches the performance criterion comprises selecting the tuple that best matches the performance criterion with regard to all traffic patterns of the context.

According to yet another variation of the first aspect, the connection tuning arrangement further comprises a context determining unit, which comprises

a clustering element that determines the context through clustering traffic instances corresponding to the traffic patterns, were each cluster corresponds to a different context, and orders, for each cluster, the data stream monitoring unit to form tuples, apply settings in tuples and determine the performance of the traffic pattern tuple combinations and orders the performance tuning unit to select and apply the settings of a tuple that best matches a performance criterion, and a context selecting element that
maps the application to a cluster at various instances in time, compares the number of times the application has been mapped to a cluster with a corresponding cluster mapping threshold, and
if the number of times the application has been mapped to the cluster exceeds the cluster mapping threshold, then selects the corresponding context to be used for the tuning.

According to a corresponding variation of the second aspect, the determining of the context is done through clustering traffic instances corresponding to the traffic patterns, where each cluster corresponds to a different context and the forming of tuples, applying of settings in tuples and determining the performance of traffic pattern and tuple combinations is performed for each cluster, the method further comprises selecting and applying the best setting for each context, mapping the application to a cluster at various instances in time, comparing the number of times the application has been mapped to a cluster with a corresponding cluster mapping threshold and if the number of times the application has been mapped to said cluster exceeds the cluster mapping threshold, then selecting (80) the corresponding context to be used for the tuning.

The context may be based on time and the performance may be based on the latency of the application.

The connection parameters may be variable with regard to access time, access frequency or database volume and the monitored application specific parameters may relate to storing data, reading data or database volume.

### BRIEF DESCRIPTION OF THE DRAWINGS

The invention will now be described in more detail in relation to the enclosed drawings, in which:

FIG. 1 schematically shows a number of data handling devices comprising applications, a number of databases as well as an access handling device,

FIG. 2 shows a block schematic of the access handling device,

FIG. 3 shows a block schematic of a data stream monitoring unit in the access handling device,

FIG. 4 shows a block schematic of a context determining unit in the access handling device,

FIG. 5 shows a flow chart of a first embodiment of a method of tuning connection parameters of a database in a federated database system,

FIG. 6 shows a flow chart of first method steps in a second embodiment of a method of tuning connection parameters of a database in a federated database system,

FIG. 7 shows a flow chart of further method steps that may be performed in the method of the second embodiment, and

FIG. 8 schematically shows a computer program product comprising a data carrier with computer program code for implementing the method for tuning connection parameters of a database in a federated database system.

### DETAILED DESCRIPTION

In the following description, for purposes of explanation and not limitation, specific details are set forth such as particular architectures, interfaces, techniques, etc. in order to provide a thorough understanding of the invention. However, it will be apparent to those skilled in the art that the invention may be practiced in other embodiments that depart from these specific details. In other instances, detailed descriptions of well-known devices, circuits and methods are omitted so as not to obscure the description of the invention with unnecessary detail.

Embodiments of the invention are directed towards a federated database system where there may exist one or more applications using corresponding databases. In such a system an application should be able to operate efficiently with regard to accessing the databases. However, in order to do this connection parameters used for such access may need to be tuned.

This tuning should furthermore be performed with a minimum of involvement by the application and the user of the application.

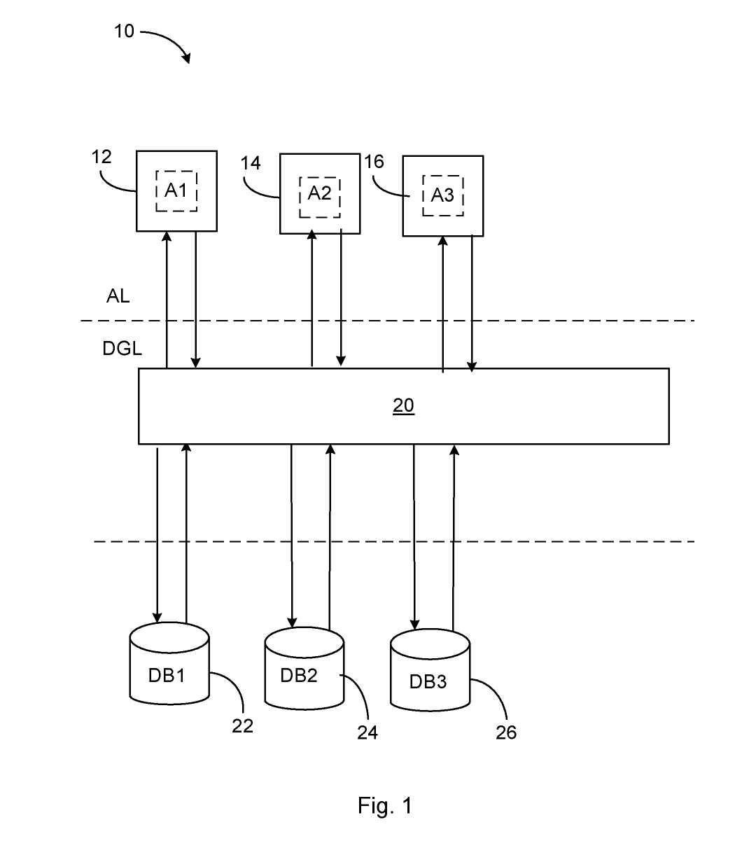

In FIG. 1 there is shown a federated database system 10, comprising a number of data handling devices.

The federated database system 10 may be a part of a larger system, such as a mobile communication system, like Long Term Evolution (LTE) or Wideband Code Division Multiple Access (WCDMA). A mobile communication system may furthermore comprise a radio access network and a core network, where the core network may provide core network functionality such as keeping track of mobile terminals and their locations. This type of functionality may be based on one or more home location registers (HLR) that may need to use the databases of the federated database system 10. It is also known for various types of third party application servers connecting to such a mobile communication system. Also these servers may need to employ the federated database system 10.

In the federated database system 10 there is a first data handling device 12, a second data handling device 14 and a third data handling device 16. In each of these data handling devices 12, 14 and 16 there is furthermore running an application which accesses one or more databases, for instance through storing or reading data. There is here a first application A1 in the first data handling device 12, a second application A2 in the second data handling device 14 and a third application A3 in the third data handling device 16. The data handling devices 12, 14 and 16 are furthermore provided in an application layer AL of the database system 10. The applications are configured to store and/or fetch data in one or more databases. Therefore, the first application A1 may access any of a first database DB1 22, a second database DB2 24 and a third database DB3 26. The second application A2 may likewise access any of the first, second or third databases 22, 24 and 26 as may the third application A3. The first database 22 may be an Hbase database, the second database may be a PostgresSqL database and the third database may be a Grapg database. The databases 22, 24 and 26 may furthermore be provided in a data layer DL of the system. It should be realized that the database types mentioned above are merely examples of database types that may be used.

The accessing of the databases is furthermore performed under the mediation of an access handling device 20. The data transfer between the applications and the databases is thus performed under the control of the access handling device 20.

The databases 22, 24 and 26 may all comprise processors such as central processing units (CPU) and data-stores in the form of memories.

As may be seen in FIG. 1, the access handling device 20 is provided in a data grid layer DGL through which data transfer between applications and databases is controlled.

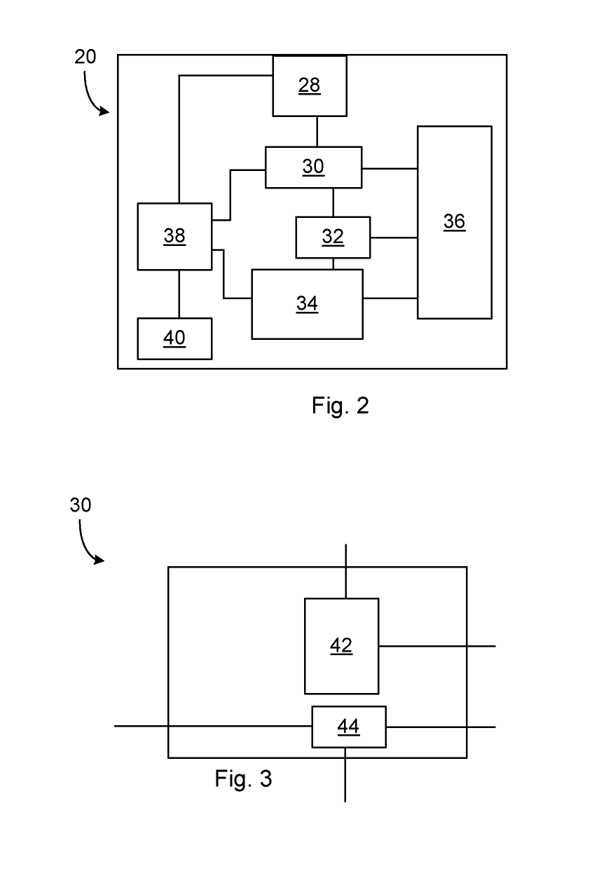

FIG. 2 shows a block schematic of the access handling device 20. It comprises a first communication interface 28 for communicating with entities in the application layer and a second communication interface 40 and for communicating with databases. It also comprises a data stream monitoring unit 30 that is connected to the first interface 28 as well as to a data storage 36. There is also a performance tuning unit 34 connected to the data storage 36. Between the data stream monitoring unit 30 and the performance tuning unit 34 there is connected an optional context determining unit 32, which context determining unit 32 is also connected to the data storage 36. Between the first and the second interfaces 28 and 40 there is furthermore connected an access handling unit 38 in order to provide access to the databases for the applications. The access handling unit 38 may for instance comprise functionality for routing queries from the applications to the corresponding databases. The performance tuning unit 34 is also connected to the access handling unit 38 as is the data stream monitoring unit 30.

FIG. 3 shows a block schematic of the data stream monitoring unit 30. The data stream monitoring unit 30 comprises a combination forming element 42 for connection to the first interface and to the data storage (not shown) as well as a performance determining element 44 for connection to the data storage, to the access handling unit and to the context determining unit (not shown).

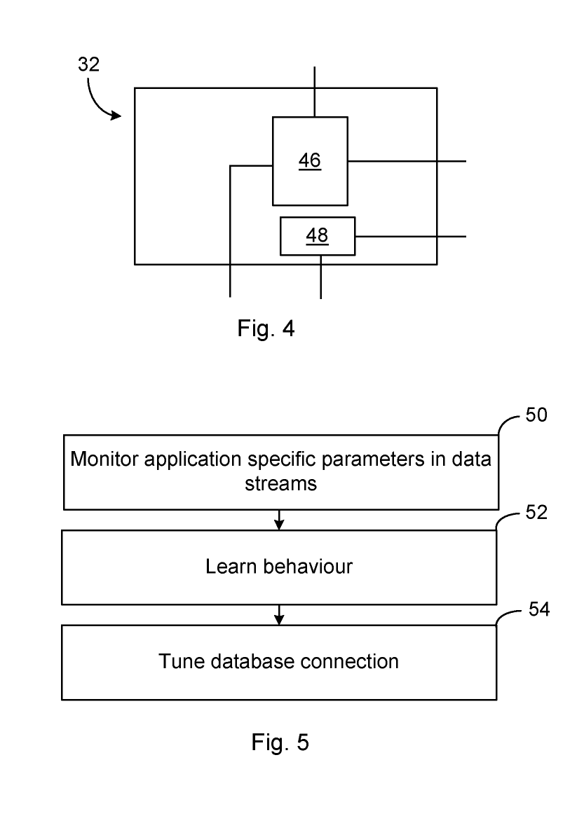

FIG. 4 shows a block schematic of the context determining unit 32. It comprises a clustering element 46 for connection to the data stream monitoring element to the performance tuning unit and to the data storage (not shown). It also comprises a context selecting element 48 for connection to the data storage and to the performance tuning unit (not shown).

Now a first embodiment will be described in more detail with reference also being made to FIGS. 1, 2 and 5, where FIG. 5 shows a flow chart of a number of method steps being performed by the data stream monitoring unit 30 and performance determining unit 34 of the access handling device 20.

In large organizations, it is inevitable for different teams in the organization to use different database management systems to store and process their data. To transform (whole) data from multiple sources (teams) into a single information model, it is required to combine the data from all the sources. More often the data sources are related.

For example, to visualize and analyze subscriber data in the Telecom domain it may be required to combine data from various data streams which gives information about events like Accounting and refill events, Life cycle events, events from charging control node, bonus events, adjustment events etc. Each of these data streams might originate from different data sources like relational database management systems (RDBMS), NoSqL, giraph etc.

The federated database system 10 is a common platform where multiple applications and multiple databases interact with each other. This system is also capable of managing applications whose data resides on multiple databases. The federated database system 10 is thereby also a system in which several databases virtually appear as a single entity for the various applications.

In operation, the applications A1, A2 and A3 sends database access requests to the access handling device 20 of the data grid layer DGL. When an application sends an access request, it is received at the first interface 28 of the data access handling device 20 and forwarded to the access handling unit 38, which selects appropriate database for the access request and then forwards it to the selected database via the second interface 40. If there is a response to the access request from the database, then this is received by the access handling device 20 at the second interface 40 and forwarded to the access handling unit 38, which then selects appropriate application and forwards the response to the application in question via the first interface 28. The access request may be a database query. However, it may also involve the storing of data in the database.

It can thereby be seen that the access handling device 20 takes care of access requests, such as queries in the system, automatically takes care of splitting and mapping them to different databases, combining possible results and rendering them back to the applications. The federated database system thereby manages and coordinates the communication between applications and data bases(s).

When a client queries an application, the system thus automatically takes care of the handling of the query and the results. Through the provision of the access handling device 20 the system provides a uniform user interface. Hence the clients can retrieve data from the applications (whose data resides in multiple databases) using a single query.

However, a user of an application may have a requirement on the performance of the system. There may thus be a performance criterion that it is of interest to fulfil. In some cases such a requirement may be that the response time should be fast. The end users of an application may thus expect a quick response time from the system to an access request. The performance may thus be based on the latency of the application.

The performance is dependent on many factors, for instance on the type of application specific parameters used by the application, such as the amount and type of addressing performed. The behaviour of the application with regard to accessing of databases is thus of interest to consider in order to improve performance. However, it is also dependent on the type of database used.

Furthermore, the fulfillment of a performance requirement is not done automatically. The system may have to be tuned for achieving a performance that is acceptable to the user.

There is therefore a need to tune the database system with regard to a performance criterion, such as a fast response time, effective resource utilization or scalability. However, the tuning of the system for performance may be totally dependent on application specific characteristics, such as the number of read and write request being performed by the application.

For applications deployed in a federated database system where Structured Query Language (SqL) databases and NoSqL databases exist, it may be complex to understand the characteristics of different data streams emanating form different applications at a particular time instance. In such environments it has up till now required human effort to track the temporal characteristics of data streams and tune the system accordingly for providing improved performance, for instance in the form of a quick response time and effective resource utilization.

With the application of data mining it is possible to continuously monitor the application specific characteristics of data streams generated by applications, learn patterns in these data streams and tune the system dynamically for good performance. There is no method/approach to handle dynamic performance tuning in a federated setup which comprises a mix of types such as both SqL and NoSqL databases. Also, systems capable of self monitoring and switching of databases automatically based on some characteristics, require manual tuning if there is an addition of a new database. This makes the problem more complex as human effort is needed to understand SqL and NoSqL database storing techniques to tune the system.

Aspects of the invention are concerned with tuning of communication parameters used for accessing databases, which tuning may be a tuning for improving performance.

The tuning being performed may be performed with regard to at least one defined context, which context may be based on time. The context may more particularly be a given time interval that is repeated regularly. A time interval may for instance be weekday mornings, such as between 8 and 10 on Mondays to Fridays. The activities of an application, for which tuning is to be performed, is then monitored with regard to this context.

The application in question, for instance the first application A1 will then access associated databases via the access handling device 20 of the data grid layer DGL. The application A1 may for instance send queries. The access request is then forwarded via the first interface 28, the access handling unit 38 and the second interface to one or more databases. The accessing of the application made will more particular give rise to a number of data streams. The data streams of the application may then be monitored. This monitoring is performed by the date stream monitoring unit 30. The data stream monitoring unit 30 may more particularly monitor the activity of the application A1 with regards to a number of application specific parameters in the data streams of the application A1, step 50. It may for instance monitor application specific parameters such as number of read requests, number of write requests and amount of database space used. The monitoring is thus also performed in at least one context.

Based on the monitored data streams, the data stream monitoring unit 30 then learns the behaviour of the application, step 52. The behaviour may be learnt through observing a number of traffic patterns in the monitored data streams. The various data streams may thus have different patterns, in which patterns the monitored parameters behave differently from each other, for instance with regard to frequency.

There may furthermore exist a number of tuneable data connection parameters. Examples of tuneable data connection parameters are default number of rows that can be pre-fetched from a database and isolation level, i.e. degree of data integrity.

In the learning of the behaviour it is possible that the data monitoring unit 30 varies these tuneable parameters in data streams having the characteristics of the traffic patterns, i.e. varies the settings of the tuneable parameters when the application A1 performs activities leading to data streams having the observed patterns. The performance of the system during the application of variations of the tuneable parameters may furthermore be monitored.

The results with regard to performance of the variations are then made accessible to the performance tuning unit 34 by the data monitoring unit 30 so that the performance tuning unit 34 may apply these results. The performance tuning unit 34 then tunes the connection parameters for the database based on the behaviour, step 54. This may involve selecting a combination of tuneable parameter settings that is closest to the performance criterion. This selection may be a section of a parameter setting combination that provides the best results with regard to all traffic patterns.

It can in this way be seen that it is possible to tune the system for an application with regard to a performance criterion, such as delay. It is thus possible to apply a different tuning for different applications. The tuning may furthermore be performed as the applications are running. There is no need to shut down or restart the system.

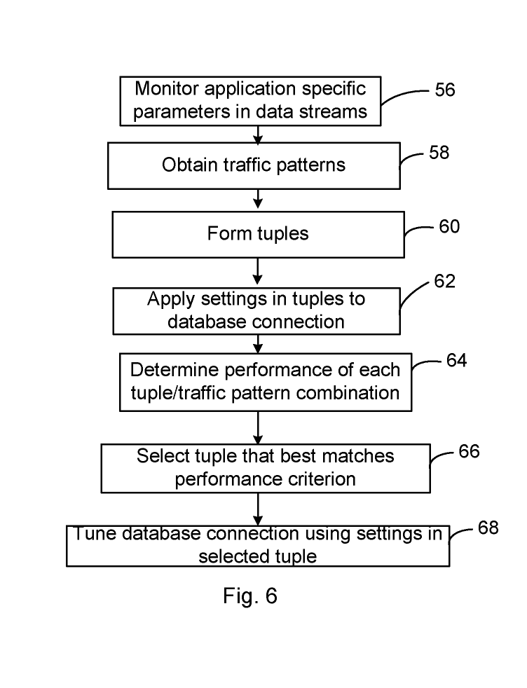

Now a first part of a second embodiment will be described with reference being made to FIG. 1-3 as well as to FIG. 6, which shows a flow chart of a number of first method steps being performed in a method of tuning connection parameters of a database in a federated database system, where the tuning is being performed in the access handling device 20.

As in the first embodiment, the data stream monitoring unit 30, and more particularly the combination forming element 42 of the data stream monitoring unit 30 monitors a number of application specific parameters in data streams of an application, here as an example in the data streams of the first application A1, step 56. The monitoring may be performed via the first interface 28. As in the first embodiment the monitoring is furthermore made in a certain context, for instance in a regularly recurring time interval, such as week days between 0800 and 10.00. As an example the monitored parameters may be the previously mentioned number of read requests, number of write requests and amount of database space used.

As an example the following results may be obtained

| | No. | No. | Amount of | |
|---|---|---|---|---|
| | Read | Write | DB Space | Traffic |
| Application | requests | requests | used | Pattern |
| A1 | 2 | 5 | 10 | T1 |
| A1 | 3 | 7 | 15 | T2 |
| A1 | 5 | 10 | 20 | T3 |

It can be seen that three traffic patterns T1, T2 and T3 have been obtained or detected s T1, T2 and T3 for the first application, step 58, where the first traffic pattern T1 comprises 2 read requests, 5 write requests and an amount of database use of 10 units, where such a unit may be a suitable unit of measuring storage space like MB. In the same manner the second and third patterns T2 and T3 are obtained, where the second traffic pattern T2 comprises 3 read requests, 7 write requests and an amount of database use of 15 units and the third traffic pattern T3 comprises 5 read requests, 10 write requests and an amount of database use of 20 units. Each traffic pattern thereby comprises different combinations of the monitored application specific parameters.

These patterns may with advantage also be obtained in relation to accesses made by the first application A1 in relation to a specific database, such as the first database 22. These patterns T1, T2 and T3 may then also be stored in the data storage 36.

Thereafter the combination forming element 42 proceeds and learns the behaviour of the data streams.

The principles of this will now be described.

In the learning of behaviour performed in this second embodiment, the combination forming element 42 now forms tuples of combinations of values of variable data connection parameters, step 60.

If it, as an example, is assumed that there are three data connection parameters P1, P2 and P3 that may be variable and thereby also tuneable. Furthermore assume that P1 is a binary variable (True/False) and that P2 and P3 are numerical variables where P2 can take a value between 1 to 100 and P3 can take a value between 1 to 4096.

The ranges that these values are typically varying between may thereafter be obtained, for instance through input form experts.

If it is assumed that these ranges are as follows:

P1—is always True
P2—Can vary between 1 to 21
P3—Can vary between 1000 to 3000

The difference in the ranges of P2 is 20 (21-1) and of P3 is 2000 (3000-1000). If it is furthermore assumed that there are steps in these variations, so that the change between values are taken in steps, where the step size of P2 is 10 and P3 is 1000.

This leads to the combination forming element 42 obtaining six different combinations or tuples of (P1,P2,P3), which tuples are the following:

### S1=(True, 1, 1000)

### S2=(True, 11, 1000)

### S3=(True, 21,1000)

### S4=(True, 1,2000)

### S5=(True, 11,2000)

### S6=(True, 21,2000)

The combination forming element 42 may now store these tuples in the data storage 36.

The combination forming element 42 then continues and applies the settings in the tuples to connection parameters of traffic instances corresponding to the obtained traffic patterns, step 62. This may involve the combination forming element 42 instructing the access handling unit 38 to apply the settings of each tuple to the corresponding connection parameters of data streams of the application A1, which data streams have a behaviour according the previously determined patterns. The access handling unit 38 is thus instructed to apply the settings of each tuple in data streams having the behaviour of the first, second and third patterns T1, T2 and T3. In this way the settings of each tuple are applied in traffic instances corresponding to the obtained traffic patterns and in this way a number of tuple traffic pattern combinations are furthermore obtained.

For each such tuple the settings of which are being applied in a data stream having a behaviour according to a traffic pattern, the performance is then determined by the performance determining element 44. This is then repeated for data streams having a behaviour according to the other traffic patterns. In this way the performance of each tuple/traffic pattern combination is determined by the combination forming element 44, step 64. If the performance is latency, then for instance the delay in responses to queries may determined by the combination forming element 44 and used for obtaining the latency of the traffic instance. The latency for each tuple applied for a specific traffic instance, is then assigned to the corresponding traffic pattern and stored in the data storage 36.

A tuple data pattern combination may then be provided as a position in a matrix, which matrix in the example above would look like:

| | S1 | S2 | S3 | S4 | S5 | S6 |
|---|---|---|---|---|---|---|
| T1 | L11 | L12 | L13 | L14 | L15 | L16 |
| T2 | L21 | L22 | L23 | L24 | L25 | L26 |
| T3 | L31 | L32 | L33 | L34 | L35 | L36 |

where L11-L36 are various performance values, here latency, associated with the different tuple traffic pattern combinations.

Thereafter the performance tuning unit 34 may investigate the matrix in the data storage 36 and select a suitable tuple for use in the context, step 66. It may thus investigate the performance values in the storage 36 and select the tuple for which the performance values best suits or matches the performance criterion with regard to the traffic patterns. In this example it selects the tuple having the lowest latency when all traffic instances of the context are considered. It may more particularly select the column of the matrix that has the lowest sum.

The performance tuning unit 34 thereby selects the tuple which provides the lowest sum of latency for all traffic patterns and assigns the settings of this tuple to the tuneable data connection parameters.

Thereafter the parameter settings of the selected tuple are used for tuning the data connection, step 68. If for instance the third tuple S3 was selected, the values therein are used. This means that P1 is set to be True, P2 is set to be 21 and P3 is set to be 1000 in the context.

It can thus be seen that the application specific characteristics of different data streams are being learnt over a pre-defined period of time (context) and the best possible settings are suggested to tune the system. It can thereby be seen that this is a typical batch system where the best setting is learnt for the given period of time, say weekdays/weekends, and the learnt setting is used to tune the system.

It can furthermore be seen that in the described aspect certain application specific parameters were monitored, the application characteristics learnt or discovered, suitable parameter values identified followed by tuning of the system for performance. These patterns were then learnt and certain connection parameters tuned to improve the performance.

The above-mentioned tuning was performed in relation to one specific application. It should be realized that the same type of tuning may be performed for the other applications.

The above described scenario was based on the supposition that the context of the tuning is known. However, this is not always the case. It may have to be discovered or found out.

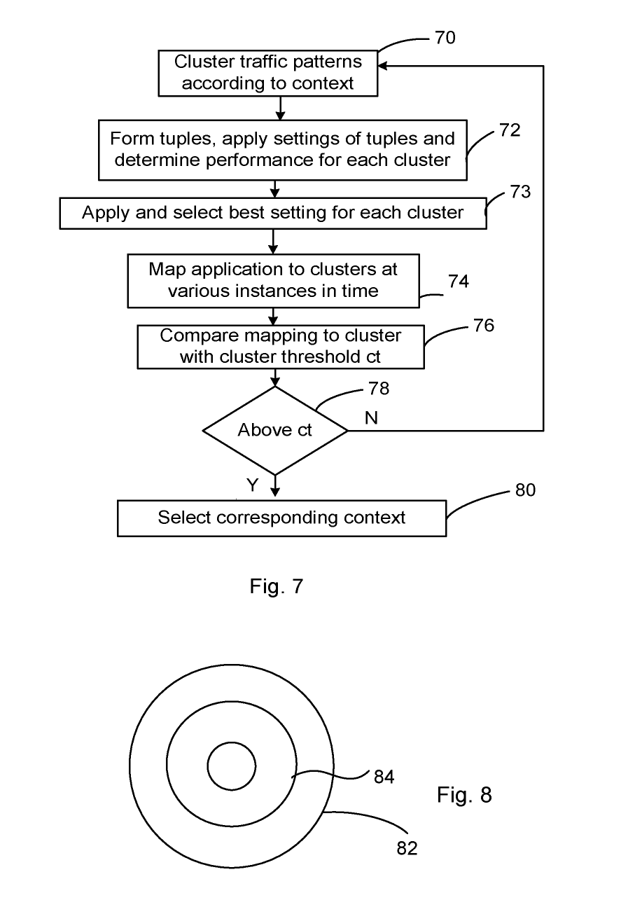

How this may be done will now be described, with reference being made to FIGS. 1, 2, 4 and 7, where FIG. 7 shows flow chart of further method steps that may be performed in the method of the second embodiment.

Pre-defining all possible contexts manually for an application might be difficult. It would be more efficient to find the contexts automatically, fir instance mornings 10 AM-12 PM might have similar data traffic characteristics. The context may be discovered dynamically and the best setting for the discovered context may be found using data mining techniques.

If it is again assumed that the traffic patterns P1, P2 and P3 are valid, where traffic instances corresponding to the traffic patterns are obtained at various points in time. In order to discover or determine the context for which tuning is to be performed the clustering element 46 of the context determining unit 32 clusters the traffic instances corresponding to traffic patterns P1, P2 and P3, step 70, were each cluster corresponds to a different context.

The traffic instances of the application can be clustered using any conventional clustering techniques like k-means. If it is assumed that k-clusters are obtained, then the k clusters may be viewed as k contexts.

For each cluster formed in this way, the clustering element 46 then orders the combination forming element 44 of the data stream monitoring unit 30 to form tuples, apply the settings in tuples in traffic instances for obtaining traffic pattern tuple combinations, and determine the performance of the traffic pattern tuple combinations, step 72. It also orders the performance tuning unit 34 to apply and select the best setting in each cluster, step 73. This means that the combination forming element 44 creates a matrix in the previously described way for each cluster. For each cluster a corresponding performance matrix P is thus constructed and the column that best fulfils the performance criterion is selected and applied.

After the clusters have been formed, the context selecting element 48 of the context determining unit 32 then maps the application A1 to a cluster at various instances in time, step 74. Once the system is built with clusters and performance matrices, the monitored traffic instances are thereby mapped to a cluster and the best setting for the application in that cluster applied.

Thereafter the context selecting element 48 compares the number of times the application has been mapped to a cluster with a corresponding cluster mapping threshold ct, step 76.

If the number of times the application has been mapped to a cluster exceeds the cluster mapping threshold ct, then the context selecting element 48 selects the corresponding context to be used for the tuning, step 80, while if the cluster threshold ct is not exceed, step 78, clustering is continued, step 70.

If the traffic instances of an application are mapped to different clusters every time, then the threshold ct, which may be configurable, may also be used to determine when to change the database settings. Assume for example that the monitoring should be done at a time interval t and the threshold ct to determine the consistency in change of application behaviour may be set as 3.

Furthermore assume that at a time t1, the first application A1 is mapped to a first cluster C1, at a time t2 to a second cluster C2, at a time t3, to the second cluster C2 once more and at a time t4, yet again to the second cluster C2.

Now, at time t5 the best setting for the application in the second cluster C2 is used to tune the system as the first application A1 has been mapped to the second cluster C2 for more than 3 times (Threshold ct).

It can in this way be seen that the context of the second cluster is the context for which tuning should be made and the settings of a tuple that best fulfils the performance criterion of this cluster are used to tune the tuneable connection parameters.

The threshold ct can be determined from the training data. For each cluster C, the value of ct can differ (transition matrix). The number of traffic parameters monitored for each application can furthermore be increased to maximise efficiency.

Through the described aspects a solution to dynamically tune the federated database system is provided, where the system may comprise multiple databases like MySqL(SqL) and hbase(NoSqL) having their own set of characteristics and tuning parameters. Through the described aspects automatic tuning of the federated database system may be achieved by continuously monitoring application specific characteristics of different data streams, applying machine learning techniques and suggesting the best possible setting for the system. This reduces manual overhead to a significant extent.

There exist a number of different application specific parameters that may be monitored where some are listed below.

Time Taken for Reads

This parameter measures the time taken for delivering the results for each of the select statements.

Time Taken for Writes

This parameter measures the time taken for each of the insert/update statements.

Frequency of Reads

This parameter measures the number of read (select) requests from the application for a given period of time.

Frequency of Writes

This parameter measures the number of write (insert/update) requests from the application for a given period of time.

Query Patterns

This parameter monitors repetitive queries.

Amount of Data Read Per Read Request

This parameter measures the number of rows read.

Amount of Data Written Per Write Request

This parameter measures the number of rows updated.

As may thus be seen, the application specific parameters may relate to storing data, reading data or database volume.

There are likewise a number of connection parameters that may be tuned, where some are listed below.

Default Row Pre-Fetch

Default number of rows that can be pre-fetched from a database server.

Default Batch Value

Default batch value that triggers an execution request.

Auto Commit Mode

Setting auto commit to true makes a row level commit. Setting it to false needs a manual commit after executing a batch of queries.

Isolation Level

Tuning database to maintain data integrity against dirty reads, non repeatable reads and phantom reads

Batch Update Statements

The performance can be reduced considerably by sending batch update statements to the database in a batch.

Batch Retrieve Result-Set

The data can be retrieved in batch by setting the fetch size which reduces the number of database calls to a greater extent.

Result-Set Direction

If the order in which the data to be processed further is known, then setting the result-set direction (fetch_forward, fetch_reverse, fetch_unknown) would improve the performance

Cache Read Only Data

In data intensive applications there will be read only tables normally called the look up tables. It will be efficient to cache these tables

Cache Frequently Read Data

Frequently read data in the database can be cached for faster retrieval and the cache can be refreshed periodically.

Pre Aggregate data

For repetitive complex queries, the system can execute the query once and store the aggregated data. On repeated request, instead of processing the query every time, it can return the pre-processed data.

As may thus be seen, the connection parameter may be variable with regard to access time, access frequency or database volume.

The previously described access handling device may form a connection tuning arrangement for tuning connection parameters of databases in the federated database system. However, it is possible that the data stream monitoring unit, performance tuning unit and optional context determining unit are provided separately from the access handling unit. In this case the data stream monitoring unit, performance tuning unit and optional context determining unit would form a connection tuning arrangement.

The connection tuning arrangement may furthermore be provided in the form of a processor with associated program memory including computer program code for performing the functionality of the data stream monitoring unit, performance tuning unit and optionally also the context determining unit and perhaps also the access handling unit.

A computer program may also be a computer program product, for instance in the form of a computer readable storage medium or data carrier, like a CD ROM disc or a memory stick, carrying such a computer program with the computer program code, which will implement the functionality of the above-described query handling device. One such data carrier 82 with computer program code 84 is schematically shown in FIG. 8.

While the invention has been described in connection with what is presently considered to be most practical and preferred embodiments, it is to be understood that the invention is not to be limited to the disclosed embodiments, but on the contrary, is intended to cover various modifications and equivalent arrangements. Therefore the invention is only to be limited by the following claims.

1. A connection tuning arrangement for tuning connection parameters of databases in a federated database system, the database system comprising a least one application configured to access one or more databases, the connection tuning arrangement comprising:
a data stream monitoring circuit configured to:
monitor a number of application specific parameters in data streams of an application, the monitoring being performed in at least one context, and
learn the behaviour of the data streams, and
a performance tuning circuit configured to tune connection parameters based on the behaviour.

2. The connection tuning arrangement according to claim 1,
wherein the data stream monitoring circuit comprises:
a combination forming element configured to:
obtain a set of traffic patterns of the application, where each traffic pattern comprises different combinations of the application specific parameters,
form tuples of combinations of values of variable connection parameters, and
apply settings in the tuples to connection parameters of traffic instances corresponding to the obtained traffic patterns, thereby forming a number of traffic pattern and tuple combinations, and
a performance determining element configured to determine the performance of each traffic pattern and tuple combination, where
the performance tuning circuit, when being configured to tune connection parameters based on the behaviour, is configured to select a tuple for use in said context,
which tuple is a tuple that best matches a performance criterion with regard to said traffic patterns.

3. The connection tuning arrangement according to claim 2, wherein the performance tuning circuit, when being configured to select a tuple that best matches the performance criterion is configured to select the tuple that best matches the performance criterion with regard to all traffic patterns of the context.

4. The connection tuning arrangement according to claim 2 further comprising a context determining circuit comprising:
a clustering element configured to determine the context through clustering traffic instances corresponding to the traffic patterns, were each cluster corresponds to a different context, and, for each cluster, order the data stream monitoring circuit to form tuples, apply settings in tuples and determine the performance of the traffic pattern tuple combinations and to order the performance tuning circuit to select and apply the settings that best matches a performance criterion, and
a context selecting element configured to
map the application to a cluster at various instances in time,
compare the number of times the application has been mapped to a cluster with a corresponding cluster mapping threshold, and
if the number of times the application has been mapped to said cluster exceeds the cluster mapping threshold, then select the corresponding context to be used for the tuning.

5. The connection tuning arrangement according to claim 1, wherein the context is based on time.

6. The connection tuning arrangement according to claim 1, wherein the performance is based on the latency of the application.

7. The connection tuning arrangement according to claim 1, wherein the connection parameters are variable with regard to access time, access frequency or database volume.

8. The connection tuning arrangement according to claim 1, wherein the monitored application specific parameters relate to storing data, reading data or database volume.

9. A method of tuning connection parameters of databases in a federated database system, the database system comprising applications configured to access one or more databases, the method being performed in a connection tuning arrangement of the system and comprising the steps of:
monitoring a number of application specific parameters in data streams of an application, the monitoring being performed in at least one context,
learning the behaviour of the data streams, and
tuning the connection parameters based on the behaviour.

10. The method according to claim 9, wherein the learning of behaviour comprises:
obtaining a set of traffic patterns of the application, each traffic pattern comprising different combinations of the application specific parameters,
forming tuples of combinations of values of variable connection parameters,
applying settings in the tuples to connection parameters of traffic instances corresponding to the obtained traffic patterns, thereby forming a number of traffic pattern and tuple combinations, and
determining the performance of each traffic pattern and tuple combination, and
the tuning comprises selecting a tuple for use in said context, which tuple is a tuple that best matches a performance criterion with regard to said traffic patterns.

11. The method according to claim 10, wherein the selecting of a tuple that best matches the performance criterion comprises selecting the tuple that best matches the performance criterion with regard to all traffic patterns of the context.

12. The method according to claim 10, further comprising determining the context through clustering traffic instances corresponding to the traffic patterns, where each cluster corresponds to a different context and the steps of forming tuples, applying settings in tuples and determining the performance of traffic pattern and tuple combinations is performed for each cluster, the method further comprising selecting and applying the best setting for each context, mapping the application to a cluster at various instances in time, comparing the number of times the application has been mapped to a cluster with a corresponding cluster mapping threshold and if the number of times the application has been mapped to said cluster exceeds the cluster mapping threshold, then selecting the corresponding context to be used for the tuning.

13. The method according to claim 9, wherein the context is based on time.

14. The method according to claim 9, wherein the performance is based on the latency of the application.

15. The method according to claim 9, wherein the connection parameters are variable with regard to access time, access frequency and database volume.

16. The method according to claim 9, wherein the monitored application specific parameters relate to storing data, reading data or database volume.

17. A computer program product comprising a non-transitory computer readable storage medium storing computer program code for tuning connection parameters of a database in a federated database system, the database system comprising applications configured to access one or more databases, the computer program comprising computer program code, which when run in a connection tuning arrangement, causes the connection tuning arrangement to:
monitor a number of application specific parameters in data streams of an application, the monitoring being performed in at least one context,
learn the behaviour of the data streams, and
tune connection parameters based on the behaviour.

18. (canceled)
